(19) United States
(12) Patent Application Publication
(10) Pub. No.: US 2012/0001720 A1
(43) Pub. Date: Jan. 5, 2012

(54) PROTECTIVE DEVICE

(75) Inventors: Yuji Kimura, Ishikawa (JP); Youzo Ohashi, Ishikawa (JP); Takahiro Asada, Ishikawa (JP)

(73) Assignee: SONY CHEMICAL & INFORMATION DEVICE CORPORATION, Tokyo (JP)

(21) Appl. No.: 13/145,611

(22) PCT Filed: Jan. 14, 2010
(86) PCT No.: PCT/JP2010/050334

§ 371 Date: Sep. 21, 2011

(30) Foreign Application Priority Data
Jan. 21, 2009 (JP) 2009-011196

(51) Int. Cl. H01H 85/50

(52) U.S. Cl. 337/297

(57) ABSTRACT

A protective device is provided that allows a fusible conductor to be fused off quickly in stability at the time of protective operation against over-current or the like. The protective device includes a fusible conductor 13 and an insulation cover 14 mounted on a base substrate 11 to overlie the fusible conductor 13. The fusible conductor, arranged on an insulating base substrate 11 and connected to a power delivery path of equipment to be protected, is fused off by a preset unusual power. The protective device also includes a flux 19 coated on the fusible conductor 13 and provided within the insulation cover 14. The fusible conductor 13 is immobilized on pair electrodes 12 and a conductor layer 17 on the base substrate 11 via a solder paste 20 containing a metal component exhibiting sufficient wettability against the fusible conductor 13 in a fused state. The solder paste 20, arranged on the pair electrodes 12 and the conductor layer 17, is spread more outwardly than the rim of the fusible conductor 13.

### TECHNICAL FIELD

This invention relates to a protective device including a fusible conductor that, when excess current flows through or excess voltage is applied to electronic equipment, is fused off under the heat generated to break the current.

### BACKGROUND ART

A conventional protective device, mounted on say a secondary cell device, has a protective function not only against the over-current but also against the over-voltage. This protective device includes a heating member and a fusible conductor layered on the heating member via an insulation layer. The fusible conductor is formed by a segment of a low melting metal and may be fused off by over-current. In case of an over-voltage, current is supplied to the heating member in the protective device, and the fusible conductor is fused off due to heating of the heating member. The fusible conductor may be fused off as a result of high wettability of the fusible conductor of a low melting metal in the fused state against the surface of the conductor layer the fusible conductor is connected to. The low melting metal in the fused state is drawn close to a conductor layer, such as an electrode, as a result of which the fusible conductor is fused off to break the current.

On the other hand, in keeping up with reduction in size of the electronic equipment, such as mobile equipment, reduction in size or thickness and stability of the operation as well as a high operating speed are demanded of the protective device. In light of this demand, such a protective device has become known in which a fusible conductor of low melting metal is arranged on an insulation substrate and sealed with an insulation cover, and in which the fusible conductor is coated with a flux. This flux is provided to prevent oxidation of the surface of the fusible conductor and to allow the fusible conductor to be fused off promptly in stability at the time of heating of the fusible conductor.

Such a type of the protective device is shown in FIGS. 13 and 14. This protective device includes a heating member 2 of a resistance material between a pair of electrodes 5a provided on both ends of a base substrate 1. A conductor layer 4 connected to one of the electrodes 5a is provided on top of the heating member 2 via insulation layer 3. Another pair of electrodes 5b is provided on the lateral sides of the base substrate 1. A fusible conductor 6, formed by a low melting metal piece, is connected between the electrodes 5b by a solder paste 7. The fusible conductor 6 is also connected to an underlying conductor layer 4 by the solder paste 7. A flux 8 is coated on the fusible conductor 6 on the base substrate 1, and an insulation cover 9 is mounted to overlie the base substrate 1 to complete the protective device.

The fusion/disruption of the fusible conductor 6 of the low melting metal due to over-current or the like may occur as follows: When the fusible conductor 6 is fused, the fusible conductor 6 in the fused state is drawn close to the conductor layer 4 and the electrodes 5b due to wettability of the fusible conductor 6 with respect to the surfaces of the electrodes 5b or the conductor layer 4 the fusible conductor is connected to. As a result, the fusible conductor 6 between the electrodes 5b is disrupted to break the current. Hence, this wettability markedly influences the current breaking characteristic.

A protective device, improved in fusion characteristic in light of the wettability and the aggregation performance at the time of fusion/disruption of the fusible conductor, is disclosed in Patent Document 1. The protective element includes an insulation substrate, a pair of electrodes mounted spaced apart from each other on the surface of the insulation substrate, and a fusible alloy conductor connected between the pair electrodes. The protective element also includes a flux deposited on the fusible alloy conductor and an insulation/sealing material that overlies the flux. An underlying layer, whose wettability against the fusible alloy conductor in the fused state is smaller than that of the insulation substrate, is formed at the fusible alloy conductor forming position. When the fusible alloy conductor is fused, the fused alloy conductor is flipped by the underlying layer and hence is disrupted promptly. Moreover, no sparking is produced at the time of fusion/disruption. The fusible alloy may readily be aggregated by its surface tension onto the electrode, thus assuring reliable disruption.

As a technique of shortening the circuit breaking time due to aggregation of the low melting metal at the time of fusion/disruption, another protective device is disclosed in Patent Document 2. In the Patent Document 2, two or more strands of low melting metal are provided between a pair of electrodes designed to cause the current to flow through the low melting metal. By so doing, the low melting metal between the electrodes is separated into independent sections to increase the number of fusion/disruption start points in the low melting metal to have the operating time shortened and improved in stability.

### Related Technical Documents

### Patent Publications

### Patent Publication 1: Japanese Laid-Open Patent Publication 2000-285777

### Patent Publication 2: Japanese Laid-Open Patent Publication 2004-214032

### SUMMARY OF THE INVENTION

### Problem to be Solved by the Invention

In the case of the protective device, shown herein in FIG. 13, the fusible conductor 6 fused off becomes aggregated on the conductor layer 4 to heap as hemisphere to come into contact with the inner surface of the insulation cover 9, as shown in FIGS. 14, 15. So, heat is dissipated to prolong the time of disruption to be deterrent to stabilized fusion/disruption. In particular, if, due to the protective device being reduced in size and thickness, the insulation cover 9 is lowered in height, with the space to allow for fusion between the base substrate 1 and the insulation cover being then reduced, fused metal tends to be contacted with the inner surface of the insulation cover 9. Viz., it is extremely difficult to accomplish reduction in thickness of the protective device and shortening or stabilizing the time duration of fusion/disruption simultaneously.

On the other hand, the fusible conductor 6 is coated with the flux 8 to prevent the fusible conductor 6 from becoming oxidized. However, on the pair electrodes 5b on both sides, to which the fusible conductor 6 in the fused state is spread as it exerts a wetting action, the flux 8 may not be coated, with the result that the electrode surface tends to be oxidized to lower the wettability. If the surfaces of the electrodes 5b are oxidized, the fusible conductor 6 in the fused state may not be spread sufficiently on the surfaces of the electrodes 5b as the fused metal exerts its wetting action. Viz., the fusible conductor 6 in the fused state may be spread, as it exerts its wetting action, only on a portion of the surface of the conductor layer 4 the fusible conductor 6 is connected to. The fusible conductor 6 in the fused state should ideally be spread, as it exerts the wetting action, on the entire surfaces of the conductor layer 4 and the electrodes 5b the fusible conductor is connected to. In the conventional configuration, however, the fusible conductor 6 in the fused state is not spread but is heaped to contact with the inner surface of the insulation cover 9, as shown in FIGS. 14, 15, thus presenting a problem that heat is dissipated to prolong the time length of fusion/disruption.

The above mentioned problem may adversely affect fusion/disruption only on rather rare occasions in case the flux of high activity is used. However, there may be raised a serious problem in case halogen-free fluxes are used to reduce the load imposed on environment by the material used. In general, halogen-free fluxes are rather low in activity, so that, if simply the flux 8 is applied on the fusible conductor 6, the fusible conductor 6 in the fused state may not be spread, as it exerts the wetting action, on the conductor layer 4 or on the electrodes 5b. There are thus met difficulties in fusing the fusible conductor 6 off promptly in stability.

In the protective device disclosed in Patent Document 1, an underlying layer whose wettability with respect to the fused alloy is lower than that of the insulation substrate is formed, and the fusible conductor 6 in the fused state is flipped by the underlying layer. Hence, the fused alloy is heaped to a higher height. Viz., with reduction in height of the insulation cover, the probability becomes higher that the fused alloy is contacted with the inner surface of the insulation cover. Thus, the above mentioned problem may become more stringent.

The protective device, disclosed in the Patent Document 2, similarly suffers the problem that, as the protective device becomes smaller in size, fused metal is more likely to come into contact with the insulation cover. Moreover, since two or more strands of low melting metal are provided by way of segmenting the low melting metal, special metal molds would have to be provided in producing the protective device, thus raising the production cost.

In light of the above depicted status of the art, it is an object of the present invention to provide a protective device in which the fusible conductor may be fused/disrupted promptly in stability for protection against over-current or the like.

### Means to Solve the Problem

According to the present invention, there is provided a protective device for protecting equipment for protection in case an unusual power is applied to the equipment for protection, in which the protective device includes a fusible conductor, an insulation cover and a flux. The fusible conductor is arranged on an insulation base substrate and connected to a power supply path for the equipment for protection so that the fusible conductor will be fused off by a preset unusual power. The insulation cover is mounted on the base substrate to cover the fusible conductor via a preset spacing, and the flux is coated on the surface of the fusible conductor and is disposed in the spacing. The fusible conductor is fused off to break its current path in case the unusual power is applied to the equipment for protection. The fusible conductor is secured to a conductor layer and to pair electrodes provided on the base substrate via an electrically conductive paste containing a metal component exhibiting high wettability with respect to the fusible conductor in the fused state. The electrically conductive paste is spread more outwards on the conductor layer than the rim of the fusible conductor.

The melting point of the metal component in the electrically conductive paste is lower than that of the fusible conductor. In particular, the electrically conductive paste is a solder paste that immobilizes the fusible conductor to the conductor layer and to the electrodes. The electrically conductive paste is provided on the electrodes in such a manner that it is spread more outwardly than the rim of the fusible conductor. After the solder paste has immobilized the fusible conductor on the electrode surface, the solder paste remains spread, as the flux component is still left.

The electrically conductive paste is spread radially on the surface of the conductor layer from the rim of the fusible conductor. In addition, the electrically conductive paste is spread radially on the surfaces of the electrodes from the rim of the fusible conductor.

The electrically conductive paste is also spread on the surface of the conductor layer from the rim of the fusible conductor to the rim of the conductor layer. Furthermore, the electrically conductive paste is spread on the surfaces of the electrodes from the rim of the fusible conductor to the rim of the electrodes.

The insulation cover includes, in a mid portion of its inner surface, a plurality of ribs that hold the flux in position.

### EFFECTS OF THE INVENTION

With the protective device of the present invention, should the fusible conductor be fused off, the fused metal is spread reliably widely on the electrode surface and on the surface of the conductor layer, as the fused metal wets these surfaces, thus assuring a stabilized prompt operation of fusion/disruption. Moreover, since the fusible conductor is not contacted with the insulation cover, there is caused no delay in the operation of fusion/disruption, thus allowing for a more stable positive operation such as to contribute to reduction in thickness of the protective device.

The solder paste used for immobilizing the fusible conductor may be used as the electrically conductive paste. Viz., it is only necessary to change the pattern of forming the solder paste, so far used to immobilize the fusible conductor, such that it is unnecessary to increase the number of process steps or costs. Moreover, the surfaces of the electrodes or the conductor layer, provided with the solder paste, may be prevented from becoming oxidized to prevent deterioration of wettability of the surfaces by the fused metal, thereby further stabilizing the fusion/disruption characteristics of the fusible conductor.

### BRIEF DESCRIPTION OF THE DRAWINGS

FIG. 1 is a plan view of a protective device of a first embodiment of the present invention, with an insulation cover removed.

FIG. 2 is a cross-sectional view taken along line A-A of FIG. 1, with the insulation cover mounted in position.

FIG. 3 is a plan view of the protective device of the first embodiment of the present invention prior to mounting the fusible conductor thereon.

FIG. 4 is a circuit diagram showing an example of use of the protective device according to the first embodiment of the present invention.

FIG. 5 is a longitudinal cross-sectional view showing the state in which the protective device according to the first embodiment has come into operation and the fusible conductor has been fused off.

FIG. 6 is a plan view showing the state in which the protective device according to the first embodiment has come into operation and the fusible conductor has been fused off.

FIG. 7 is a plan view showing a solder paste coating pattern according to a second embodiment of the present invention.

FIG. 8 is a plan view showing a state in which the protective device of the second embodiment of the present invention has come into operation and the fusible conductor has been fused off.

FIG. 9 is a plan view showing a solder paste coating pattern according to a third embodiment of the present invention.

FIG. 10 is a plan view showing a state in which the protective device of the third embodiment of the present invention has come into operation and the fusible conductor has been fused off

FIG. 11 is a longitudinal cross-sectional view of a protective device according to a fourth embodiment of the present invention.

FIG. 12 is a longitudinal cross-sectional view showing a state in which the protective device of the fourth embodiment of the present invention has come into operation and the fusible conductor has been fused off

FIG. 13 is a longitudinal cross-sectional view of a conventional protective device.

FIG. 14 is a plan view showing a state in which the conventional protective device has come into operation and the fusible conductor has been fused off

FIG. 15 is a longitudinal cross-sectional view showing a state in which the conventional protective device has come into operation and the fusible conductor has been fused off.

### BEST MODE FOR CARRYING OUT THE INVENTION

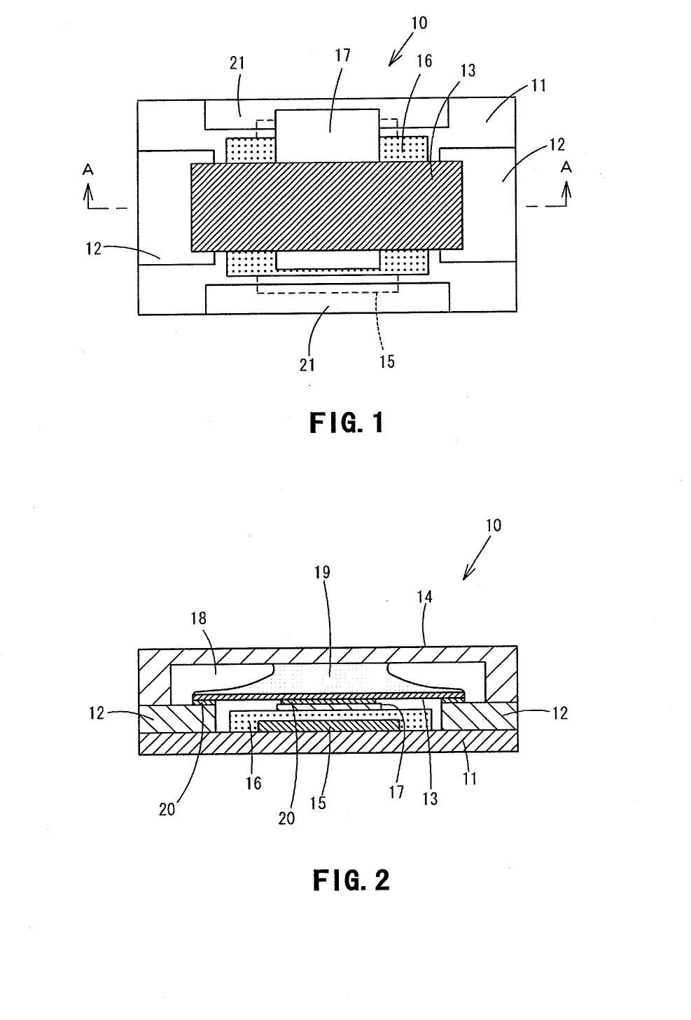

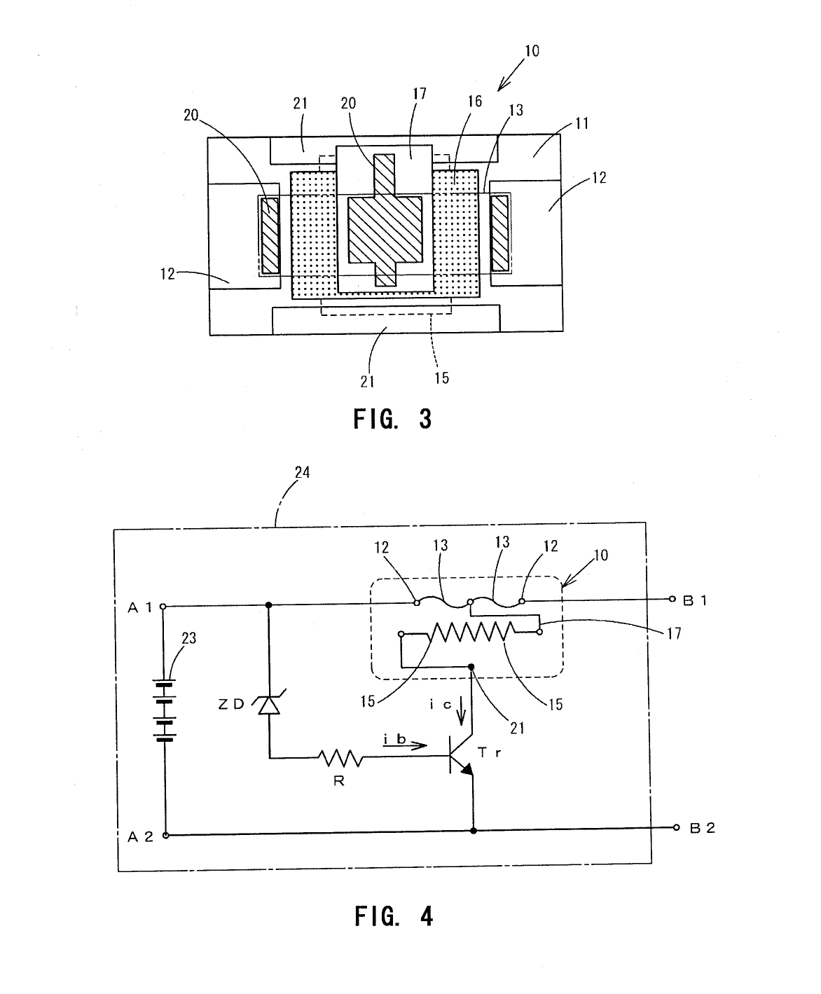

A first embodiment of a protective device of the present invention will now be described with reference to FIGS. 1 to 6. A protective device 10 of the present embodiment includes an insulating base substrate 11 carrying thereon a pair of electrodes 12 and another pair of electrodes 21. The pair electrodes 12 are mounted at both ends on an upper major surface of the insulating base substrate 11. The other pair electrodes 21 are mounted on lateral side edges of the insulating base substrate 11 perpendicular to the pair electrodes 12. A heating member 15 composed of a resistor is connected to the pair electrodes 21. An electrically conductive layer 17, connected to one of the pair electrodes 21 via an insulation layer 16, is layered on top of the heating member 15. A solder paste 20 is coated on the electrically conductive layer 17 and on the pair electrodes 12. A fusible conductor 13, a fuse formed of low melting metal, is connected and secured between the pair electrodes 12 via the solder paste 20. On top of the base substrate 11, there is mounted an insulation cover 14 of an insulation material for facing the fusible conductor 13.

The base substrate 11 may be of any suitable material provided that the material is insulating. An insulating substrate routinely used as a substrate for a printed circuit board, such as ceramic substrate or glass epoxy substrate, for example, is desirable. A glass substrate, a resin substrate and a metal substrate processed for insulation, may also be used depending on the use or application. A ceramic substrate, exhibiting high thermal resistance and high heat conductivity, is most desirable.

For the electrodes 12, 21 and the electrically conductive layer 17, a metal foil, such as copper foil, or an electrically conductive layer, having its surface plated with Ag—Pt or Au, may be used. The electrically conductive layer 17 as well as the electrodes 12, 21, obtained on coating an electrically conductive paste, such as Ag paste, on the base substrate 11, and sintering the resulting assembly, may also be used. Or, the electrically conductive layer 17 as well as the electrodes 12, 21 may be of a thin metal film structure obtained on vapor deposition.

It is sufficient that the low melting metal foil of the fusible conductor 13 is melted at a preset electrical power. A variety of known low melting metals may be used as a fuse material. Examples of the fuse material include BiSnPb alloys, BiPbSn alloys, BiPb alloys, BiSn alloys, SnPb alloys, SnAg alloys, PbIn alloys, ZnAl alloys, InSn alloys and PbAgSn alloys.

The resistor that composes the heating member 15 may be obtained as follows: A resistor paste, composed of an electrically conductive material, such as ruthenium oxide or carbon black, an inorganic binder, such as glass and/or an organic binder, such as thermosetting resin, is coated on the base substrate 11, and the resulting product is sintered to yield the resistor. A thin film of ruthenium oxide and carbon black may also be printed on the base substrate 11 and a resulting product may then be sintered to yield the resistor. Or, ruthenium oxide and carbon black may be formed into a film by plating, vapor deposition or sputtering on the base substrate 11. Or, a film of the resistor material may be bonded or deposited on the base substrate 11 to form the resistor.

The insulation cover 14, mounted on the base substrate 11, is in the form of a casing, having its one lateral side opened, and is fitted on the base substrate 11 such as to delimit a preset spacing 18 between it and the fusible conductor 13. It is sufficient that the insulation cover 14 is formed of an insulating material exhibiting thermal resistance high enough to bear the heat at the time of fusion/disruption of the fusible conductor 13 and also exhibiting mechanical strength proper to the protective device 10. A variety of materials, including a substrate material used for a printed circuit board, such as glass, ceramics, plastics or glass epoxy resin, may be used. The insulation cover may also be formed by a metal sheet, whose side facing the base substrate 11 has an insulation layer, such as insulation resin layer. Preferably, such a material having high mechanical strength and a high insulation property, such as ceramics, is used since it contributes to advantage to reducing the thickness of the protective device on the whole.

A flux 19 is provided on the entire surface of the fusible conductor 13 to prevent oxidation of the conductor surface. Preferably, no halogen elements, such as bromine, are contained in the flux 19, viz., the flux is to be halogen-free. The flux 19 is retained by surface tension on the fusible conductor 13 and accommodated in the spacing 18. It is also affixed to the inner surface of the insulation cover 14 so as to be retained thereon by surface tension, as shown in FIG. 2.

The solder paste 20 contains a metal component exhibiting high wettability against the fusible conductor 13 which is in the fused state. The solder paste is preferably lead-free. For example, a zinc (Sn)-, silver (Ag)- or a copper (Cu)-based solder paste may be used. The solder paste is composed of a flux material containing metal alloy particles, such as particles of Sn alloys. The flux used in the solder paste is also preferably halogen-free. The fusing temperature of metal alloy particles in the solder paste 20 is preferably not higher than the fusing temperature of the fusible conductor 13 and, more preferably, is as close to the fusing temperature of the fusible conductor 13 as possible. Viz., the metal alloy particles in the solder paste 20 are fused at a temperature lower than the fusing temperature of the fusible conductor 13 preferably by 10° C. or less. The coating pattern of the solder paste 20 is such that it deviates from a surface portion of the electrically conductive layer 17 of deposition of the fusible conductor 13 and extends towards the transverse edges of the electrically conductive layer 17. In addition, the solder paste 20 is coated on substantially the entire area of the portion of each of the pair electrodes 12 where the fusible conductor 13 is deposited.

The fusible conductor 13 is placed on the portions of the pair electrodes 12 and the electrically conductive layer 17 where the solder paste 20 has been printed to the above mentioned preset pattern. The resulting assembly then is cured in a reflow oven. The curing at this time is at a temperature for which the fusible conductor 13 is not completely fused. The fusible conductor 13 is thus fixed in position on top of the pair electrodes 12 and the electrically conductive layer 17 in such a state that the metal alloy particles in the solder paste 20 are not completely fused and the flux material is also left.

As an example of using the protective device 10 of the present embodiment for electronic equipment, an over-current over-voltage protective circuit 24 for a secondary cell device will now be explained with reference to FIG. 4. In this over-current over-voltage protective circuit 24, the pair electrodes 12 of the protective device 10 are connected in series between an output terminal A1 and an input terminal B1. The terminal of one of the pair electrodes 12 of the protective device 10 is connected to the input terminal B1, while the terminal of the other electrode 12 is connected to the output terminal A1. The fusible conductor 13 has its median point connected to one terminal of the heating member 15 and the terminal of one of the electrodes 21 is connected to the other terminal of the heating member 15. The other terminal of the heating member 15 is connected to the collector of a transistor Tr, the emitter of which is connected to a point intermediate between another input terminal A2 and another output terminal B2. A Zener diode ZD has an anode connected via a resistor R to the base of the transistor Tr. The cathode of the Zener diode ZD is connected to the output terminal A1. The resistor R is set to a value such that, in case a voltage set as an unusual voltage is applied across the output terminals A1 and A2, a voltage in excess of a breakdown voltage will be applied to the Zener diode ZD.

There are connected electrode terminals of a plurality of secondary cells 23, such as lithium cells, as devices for protection, across the output terminal A1, A2, while there are connected electrode terminals of a device, such as a charger, not shown, across the input terminals B1 and B2. This device is used as it is connected to the secondary cells 23.

The operation of the protective device 10 of the present embodiment will now be explained. It is supposed that, in the secondary cell devices, such as the lithium cell devices, provided with the over-current over-voltage protective circuit 24 of the present embodiment, an unusual voltage is applied across its output terminals A1, A2 during charging of the cell devices. In this case, a reverse voltage in excess of the breakdown voltage is applied to the Zener diode ZD at a preset voltage as an unusual voltage. Hence, the Zener diode ZD is rendered electrically conductive. Since the Zener diode ZD is now electrically conductive, a base current Ib flows through the base of the transistor Tr to turn it on. Hence, a collector current Ic flows through the heating member 15 to cause it to be heated. The heat thus evolved in the heating member 15 is transmitted to the fusible conductor 13 of the low melting metal mounted on top of the heating member 15 to fuse the fusible conductor 13 off. This breaks the electrical connection between the input terminal B1 and the output terminal A1 to prevent an over-voltage from being applied across the output terminals A1 and A2. In case an unusual current flows towards the output terminal A1, the fusible conductor 13 is similarly heated by the current so as to be fused off.

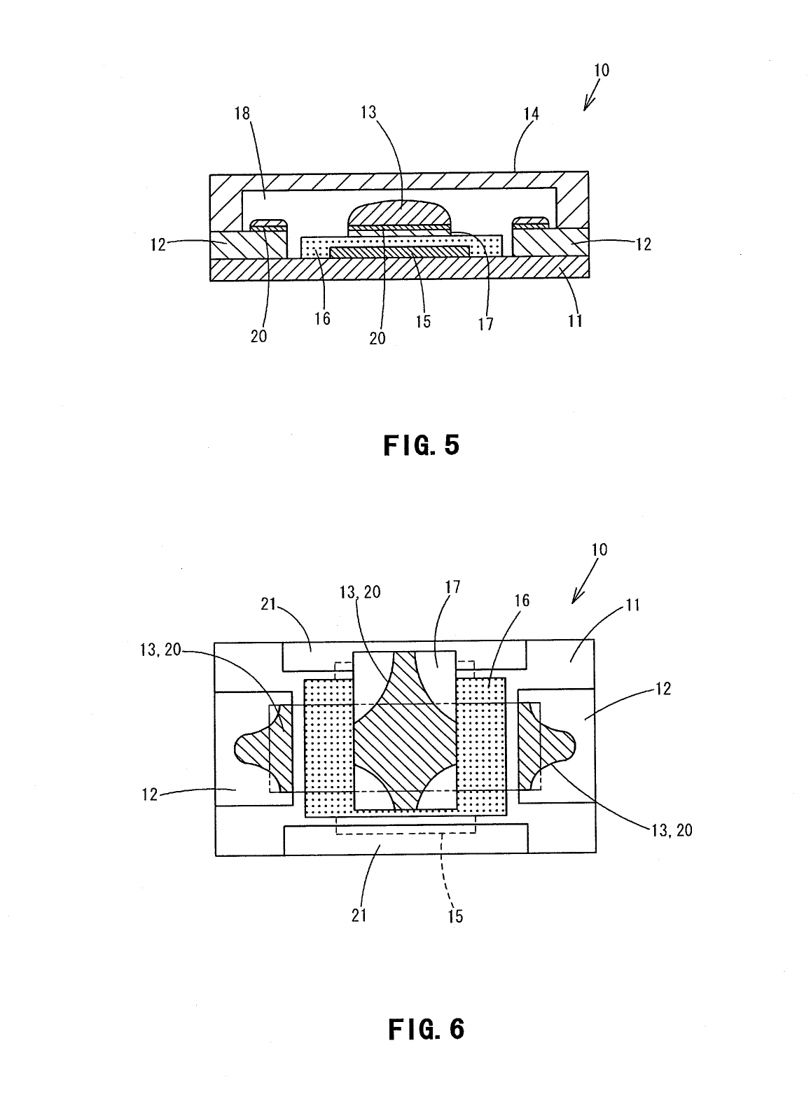

Turning to the protective operation by the protective device 10, the metal alloy particles of the solder paste 20 are initially fused and spread over the electrodes 12 and the electrically conductive layer 17. Almost simultaneously, the fusible conductor 13 is fused off and hence is disrupted, as shown in FIG. 5. At the time of fusion/disruption of the fusible conductor 13, it is spread widely as it wets the electrodes 12 and the electrically conductive layer 17, over which the solder paste 20 has already become fused and spread as it exerts a wetting action, as shown in FIG. 6. As a result, there is no risk that the fusible conductor 13 heaps up in the spacing 18 below the insulation cover 14 to contact the inner surface of the insulation cover 14.

In the protective device 10 of the present embodiment, when the fusible conductor 13 is about to be fused off, the solder paste 20 is initially spread widely over the surfaces of the electrodes 12 and the electrically conductive layer 17 to wet the surfaces to provide for stable quick fusion/disruption. Moreover, since the fusible conductor 13 is not contacted with the insulation cover 14, there is caused no fusion/disruption delay, thereby assuring the stable reliable protective operation to render it possible to formulate the protective device of the thinner thickness. In addition, the solder paste 20 simultaneously serves as a solder that immobilizes the fusible conductor 13 in position. Hence, the solder paste 20 may be implemented simply by changing the pattern of forming the conventional immobilizing solder paste 20 without increasing the number of steps or costs. Furthermore, the surfaces of the electrodes 12 and the electrically conductive layer 17, provided with the solder paste 20, may be prevented from becoming oxidized, thereby further stabilizing the fusion/disruption characteristics of the fusible conductor 13. In particular, in the characteristics of the low-power heating operation, variations in the operation may be made significantly smaller than in the conventional system. The protective device 10 of high performance may thus be provided which is far less in operation variations than in the conventional system and which may reduce the load otherwise imposed on environment.

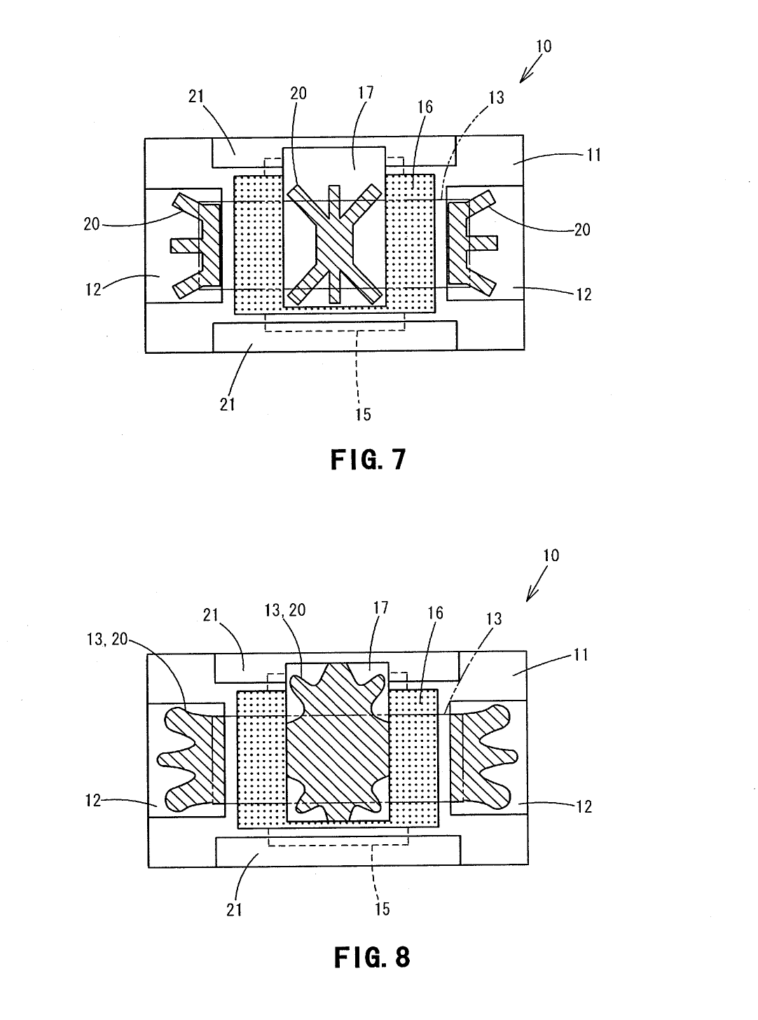

A second embodiment of the protective device according to the present invention will now be explained with reference to FIGS. 7 and 8. The components which are similar to those of the above embodiment are depicted by the same reference numerals and hence the corresponding explanation is dispensed with. In the protective device 10 of the present embodiment, the printing pattern of the solder paste 20 that immobilizes the fusible conductor 13 is changed from that of the previous embodiment. Specifically, the printing lines of the solder paste 20 are extended radially from the mounting position of the fusible conductor 13, as shown in FIG. 7.

Turning to the protective operation by the protective device 10, the metal alloy particles of the solder paste 20 are initially fused and spread over the electrodes 12 and the electrically conductive layer 17, as shown in FIG. 8. Almost simultaneously, the fusible conductor 13 becomes fused off. At this time, the fusible conductor 13 is widely spread over the pattern of fusion of the solder paste 20, as the fusible conductor exerts its wetting action, as shown in FIG. 8. Hence, the fused metal of the fusible conductor 13 heaps to a lesser height. This indicates that the present embodiment may be applied to a protective device of a thinner thickness.

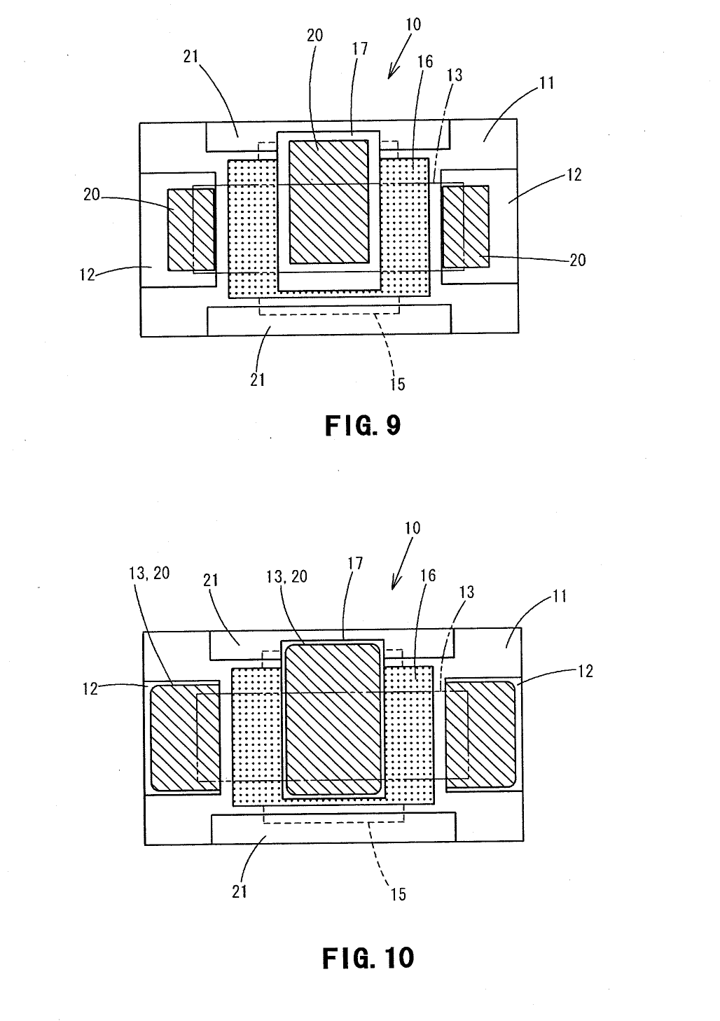

A third embodiment of the protective device according to the present invention will now be explained with reference to FIGS. 9 and 10. The components which are similar to those of the above embodiments are depicted by the same reference numerals and the corresponding explanation is dispensed with. In the protective device 10 of the present embodiment, the printing pattern of the solder paste 20 that immobilizes the fusible conductor 13 is further changed. Viz., the solder paste 20 is printed or coated on a major portion of the surfaces of the electrodes 12 and the electrically conductive layer 17 where the fusible conductor 13 is mounted, as shown in FIG. 9.

In this case, during the operation of protection by the protective device 10, metal alloy particles of the solder paste 20 are fused more widely, and are spread more widely as the solder paste exerts its wetting action, as shown in FIG. 10. Hence, the fused metal of the fusible conductor 13 heaps only to a still lesser height than in the above embodiments. This indicates that the present embodiment may be applied to a protective device of a still thinner thickness.

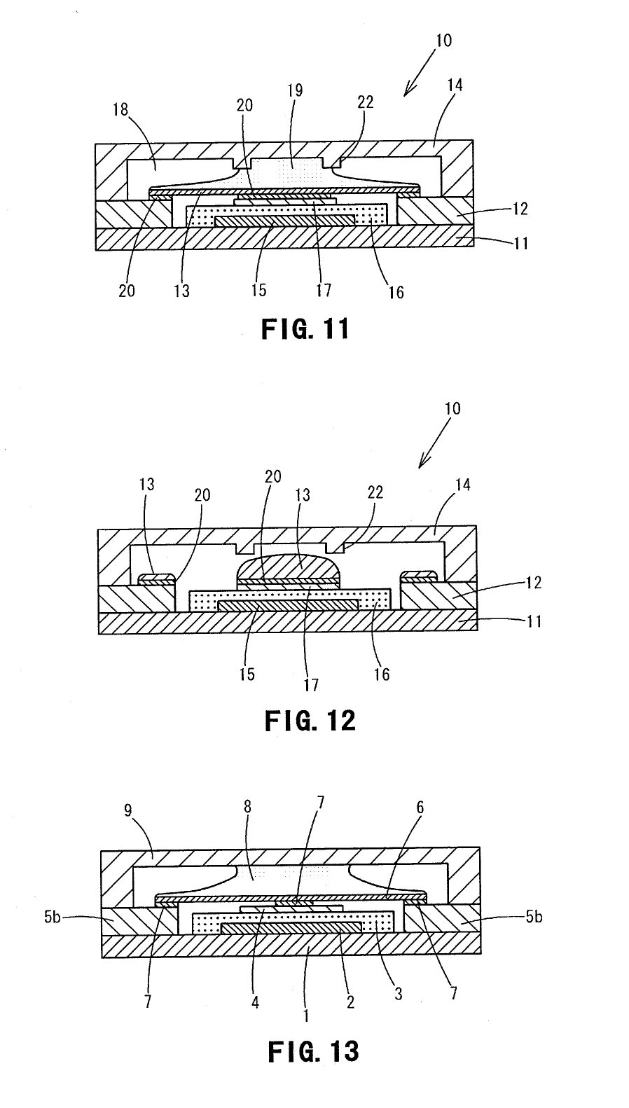

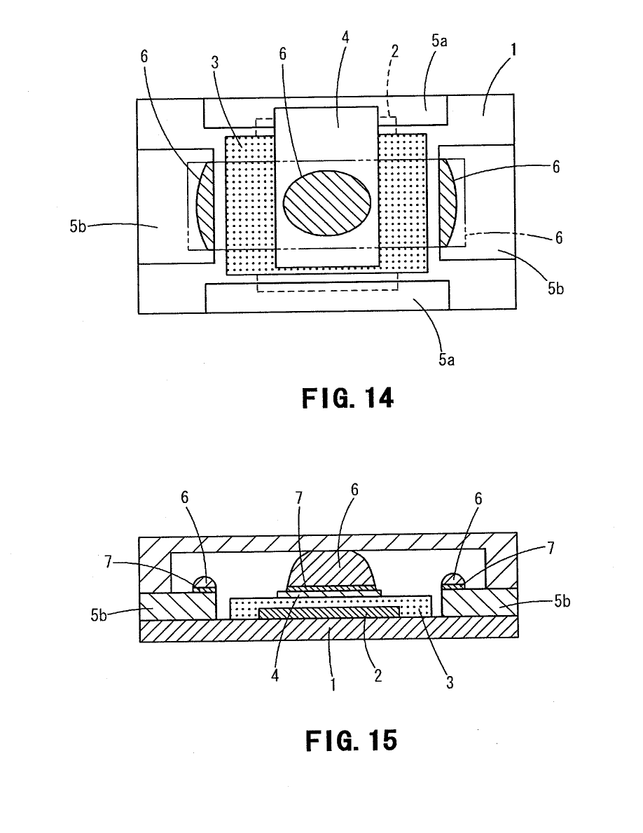

A fourth embodiment of the protective device according to the present invention will now be explained with reference to FIGS. 11 and 12. The components which are similar to those of the above embodiments are depicted by the same reference numerals and the corresponding explanation is dispensed with. In the protective device 10 of the present embodiment, the printing pattern of the solder paste 20 that immobilizes the fusible conductor 13 is the same as that of the above embodiments. However, in the present embodiment, a plurality of, herein two, ribs 22 for holding the flux 19 are provided at a mid portion of the inner surface of the insulation cover 14, as shown in FIG. 11. The ribs are formed as one with the insulation cover 14.

In the present embodiment, the flux 19 may be held positively by the ribs 22 formed on the inner surface of the insulation cover 14, so that the flux may be stably retained at the center position of the fusible conductor 13 without position shifting. This may assure a stabilized operation of fusion/disruption. At the time of fusion/disruption, the fusible conductor 13 is not heaped to a higher height such that it is not contacted with the ribs 22, as shown in FIG. 12. Hence, there is no adverse effect that might otherwise be caused by the ribs 22, such as delay in fusion/disruption.

The protective device according to the present invention is not limited to the above embodiment. For example, the solder paste material or its coating pattern may be selected in a desired manner. There is also no limitation to the types of the flux or other material, which may thus be formed of any suitable desired material.

### Explanation of Reference Numerals

10 protective device

11 base substrate

12, 21 pair electrodes

13 fusible conductor

14 insulation cover

15 heating member

16 insulation layer

17 electrically conductive layer

19 flux

20 solder paste

1. A protective device for protecting equipment for protection in case an unusual power is applied to the equipment for protection, comprising:
a fusible conductor arranged on an insulation base substrate and connected to a power supply path for the equipment for protection so that the fusible conductor will be fused off by a preset unusual power;
an insulation cover mounted on the base substrate to overlie the fusible conductor via a preset spacing; and
a flux coated on the surface of the fusible conductor and disposed in the spacing;
the fusible conductor being fused off to break a current path thereof in case the unusual power is applied to the equipment for protection; wherein
the fusible conductor is secured to a conductor layer and to pair electrodes provided on the base substrate via an electrically conductive paste containing a metal component exhibiting high wettability with respect to the fusible conductor in the fused state;
the electrically conductive paste being spread more outwards on the conductor layer than the rim of the fusible conductor.

2. The protective device according to claim 1, wherein
the melting temperature of the metal component in the electrically conductive paste is lower than that of the fusible conductor.

3. The protective device according to claim 2, wherein
the electrically conductive paste is a solder paste that immobilizes the fusible conductor with respect to the conductor layer and the pair electrodes.

4. The protective device according to claim 2, wherein
the electrically conductive paste is spread more outwardly on the electrodes than the rim of the fusible conductor.

5. The protective device according to claim 3, wherein
even after the solder paste has immobilized the fusible conductor on the surfaces of the electrodes, the solder paste is spread as a flux component of the solder paste is left.

6. The protective device according to claim 2, wherein
the electrically conductive paste is spread radially from the rim of the fusible conductor on the surface of the conductor layer.

7. The protective device according to claim 4, wherein
the electrically conductive paste is spread radially from the rim of the fusible conductor on the surfaces of the electrodes.

8. The protective device according to claim 2, wherein
the electrically conductive paste is spread on the surface of the conductor layer from the rim of the fusible conductor towards the rim of the conductor layer.

9. The protective device according to claim 4, wherein
the electrically conductive paste is spread on the surfaces of the electrodes from the rim of the fusible conductor towards the rims of the electrodes.

10. The protective device according to claim 3, wherein
the insulation cover includes a rib at a mid portion of an inner surface thereof; the rib holding the flux.
